(19) United States
(12) Patent Application Publication
(10) Pub. No.: US 2019/0341157 A1
(43) Pub. Date: Nov. 7, 2019

(54) PASSIVE MOLTEN CORE COOLING DEVICE

(71) Applicant: KOREA HYDRO & NUCLEAR POWER CO., LTD., Gyeongsangbuk-do (KR)

(72) Inventors: Sun Heo, Daejeon (KR); Do Hyun HWANG, Sejong (KR)

(73) Assignee: KOREA HYDRO & NUCLEAR POWER CO., LTD., Gyeongsangbuk-do (KR)

(21) Appl. No.: 16/475,024

(22) PCT Filed: Jan. 2, 2018
(86) PCT No.: PCT/KR2018/000004

§ 371 Date: Jun. 28, 2019

(30) Foreign Application Priority Data
Jan. 3, 2017 (KR) 10-2017-0000817

(51) Int. Cl. G21C 15/18; G21C 15/243; G21C 9/016

(52) U.S. Cl. CPC G21C 15/18; G21C 9/016; G21C 15/243

(57) ABSTRACT

The present invention relates to a passive molten core cooling device comprising: a reactor vessel; a core catcher positioned at the lower part of the reactor vessel; a flow path structure positioned at the lower part of the core catcher, and having a coolant flow path filled with a coolant; and a coolant tank communicating with the flow path structure through a first pipe and supplying coolant to the coolant flow path through the first pipe, wherein the coolant flow path is divided into a first flow path adjacent to the core catcher and a second flow path spaced from the core catcher, and the first flow path and the second flow path are connected to each other

### TECHNICAL FIELD

The present invention relates to a passive molten core cooling apparatus for cooling a molten core in a severe accident when a core contained in a reactor vessel is melted.

### BACKGROUND ART

During a normal operation of a nuclear power plant, a core inside a reactor vessel is cooled by coolant circulated by a coolant pump. However, when a severe accident such as a coolant loss or a loss of the pump power occurs, core cooling will no longer be performed. Thus, the temperature of the core is increased and reaches the core melting temperature. Thus, the core is melted and the molten core is relocated on a bottom of the nuclear reactor vessel.

In this severe accident, a molten core cooling method is used to cool the molten core by supplying coolant. A core catcher as a molten core collecting and cooling facility is installed on the bottom of the reactor cavity to cool the molten core vertically.

In the conventional approach, the coolant is not filled in the reactor cavity before the accident. In the event of a severe accident in which the molten core is discharged into the reactor cavity, and at the moment the molten core is expected to be released, the coolant is filled into the reactor cavity. This is to prevent the phenomena such as steam explosion occurring when the high temperature molten core may encounter with the low-temperature coolant, and to facilitate the operation of the nuclear power plant. Further, in order to supply the coolant, it is necessary to operate the motor-operated valve via determination of the operator or via an automatic circuit driven by the measuring device and the control equipment. Alternatively, a method using a mechanical valve driven by the molten core discharge has been used in order to supply the coolant.

However, in the conventional approach, there are various factors such as failure of the equipment and facilities, loss of the operating power of the equipment due to long-term accident progress, adverse effects due to malfunction of the equipment, or the operator's misjudgment, etc. Those could seriously affect the safety of the plant.

### DISCLOSURE

### Technical Problem

Accordingly, the present invention has been made to solve the above-mentioned problems. The present invention provides a passive molten core cooling apparatus for cooling a molten core in a severe accident that a core accommodated in a reactor vessel is melted.

### Technical Solution

In one aspect, there is proposed a passive molten core cooling apparatus comprising: a reactor vessel; a core catcher located below the reactor vessel; a channel structure having a coolant channel located below the core catcher and filled with a coolant; and a coolant tank communicating with the channel structure through a first pipe and supplying a coolant to the coolant channel through the first pipe, wherein the coolant channel is divided into a first channel adjacent to the core catcher and a second channel spaced away from the core catcher, wherein the first channel and the second channel are communicated to each other.

In one embodiment of the passive molten core cooling apparatus of claim 1, when a severe accident occurs, the coolant rises up along the first channel, and the coolant descends along the second channel, such that the coolant is spontaneously circulated through the coolant channel.

In one embodiment of the passive molten core cooling apparatus, the coolant channel includes: a start portion of an upwards path along which the coolant begins to rise up along the first channel; and a start portion of a downwards path along which the coolant begins to descend along the second channel.

In one embodiment of the passive molten core cooling apparatus, the coolant channel is constructed such that the first channel and the second channel are in communication with each other at the start portion of the upwards path and the start portion of the downwards path.

In one embodiment of the passive molten core cooling apparatus, the channel structure includes a partition member for partitioning the coolant channel into the first channel and the second channel.

In one embodiment of the passive molten core cooling apparatus, the partition member has a plate shape.

In one embodiment of the passive molten core cooling apparatus, the apparatus further includes a second pipe, wherein one end of the second pipe is in communication with the channel structure, and the other end thereof is exposed to an atmosphere, wherein the second pipe discharges vapor generated via the coolant circulation in the coolant channel to the atmosphere.

In one embodiment of the passive molten core cooling apparatus, the coolant tank is disposed above the channel structure.

In one embodiment of the passive molten core cooling apparatus, the coolant tank has: a first space filled with the coolant; and a second space, wherein steam discharged through the second pipe is discharged into the atmosphere through the second space.

In another aspect, there is provided a passive molten core cooling apparatus comprising: a nuclear reactor vessel; a core catcher located below the nuclear reactor vessel; a channel structure having a coolant channel located below the core catcher and filled with a coolant, wherein the channel structure includes a partition member for partitioning the coolant channel into a first channel and a second channel; a coolant tank for supplying a coolant to the coolant channel; a first pipe communicating with the coolant tank; and a second pipe for discharging vapor generated in the channel structure to atmosphere, wherein the coolant in the coolant channel upwardly and downwardly flows and thus spontaneously circulates in the coolant channel, wherein coolant is replenished passively from the coolant tank by an amount of coolant as discharged through the second pipe in a vapor state.

In one embodiment of the passive molten core cooling apparatus, the coolant channel is divided by the partition member into a first channel adjacent to the core catcher and a second channel spaced away from the core catcher, wherein the first channel and the second channel are communicated to each other.

### Advantageous Effects

According to the present invention, the passive molten core cooling apparatus is provided to cool the molten core in the event of accidentally melting the core contained in the nuclear reactor vessel.

Further, the passive molten core cooling apparatus is provided that maintains a constant coolant amount due to hot molten core and coolant heating, natural circulation by boiling, and passive replenishment of coolant from the coolant tank. In this connection, any mechanical parts that need to be operated for the operation of the equipment are not required. This can prevent the effects from the equipment failure or operator's mistake.

In addition, the molten core and coolant cannot come into direct contact with each other, so that the molten core-coolant reaction leading to the steam explosion can be prevented.

### DESCRIPTION OF DRAWINGS

FIG. 1 is a cross-sectional view of a passive molten core cooling apparatus according to one embodiment of the present invention.

FIG. 2 is an enlarged cross-sectional view of a channel structure of FIG. 1.

FIG. 3 is a cross-sectional view of a passive molten core cooling apparatus showing circulation of coolant according to one embodiment of the present invention.

### MODE FOR INVENTION

The present invention will now be described in more detail with reference to the drawings.

The accompanying drawings are merely illustrative examples for the purpose of more specifically describing the technical idea of the present invention, and thus the idea of the present invention is not limited to the accompanying drawings. Further, the accompanying drawings may be exaggerated in size and spacing in order to describe the relationship between components.

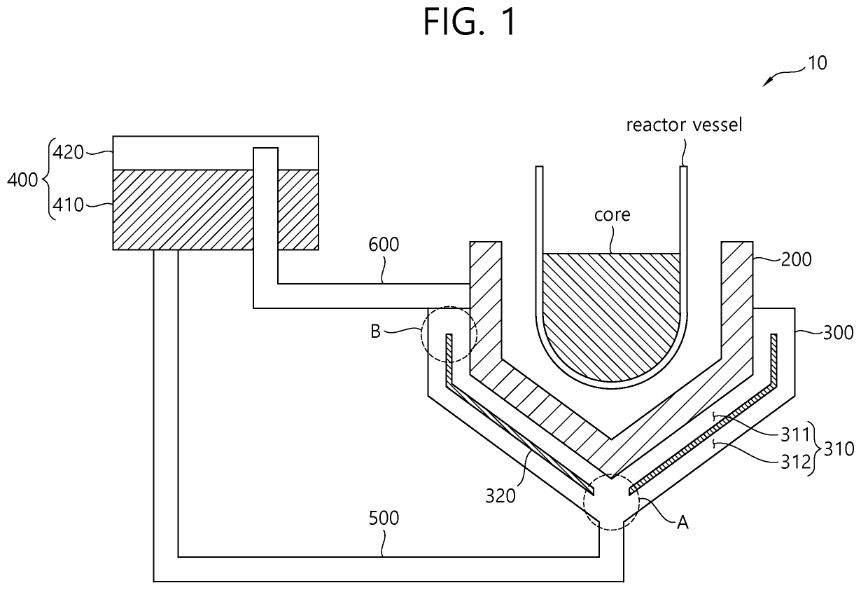

Referring to FIG. 1, a passive molten core cooling apparatus according to one embodiment of the present invention is described.

FIG. 1 is a cross-sectional view of a passive molten core cooling apparatus according to one embodiment of the present invention.

A passive molten core cooling apparatus 10 according to one embodiment of the present invention includes a nuclear reactor vessel, a core catcher 200 located below the nuclear reactor vessel, a channel structure 300 having a coolant channel 310 and located below the core catcher 200 and filled with a coolant, and a coolant tank 400 communication with the channel structure 300 via a first pipe 500 for supplying a coolant to the coolant channel 310 through the first pipe 500.

Further, the device 10 includes a second pipe 600. One end of the second pipe communicates with the channel structure 300 while the other end of the second pipe is exposed to the atmosphere. The second pipe discharges the steam generated through the coolant circulation in the coolant channel 310 to the atmosphere.

The core is located inside the nuclear reactor vessel.

The core catcher 200 is disposed outside the reactor vessel and spaced from the vessel at a predetermined spacing and surrounds the nuclear reactor vessel.

The core catcher 200 may be made of a metal material. However, the present invention is not limited thereto. In order to support the load of the molten core, the thickness of the core catcher may be larger than a certain thickness. For example, the thickness is several centimeters or larger.

Although not shown, a sacrificial material layer may be positioned between the reactor vessel and the core catcher 200. The sacrificial material layer is intended to prevent impact due to high-temperature molten core release in the event of severe accident, and to melt into the molten core to reduce an amount of heat generation per unit volume.

The channel structure 300 is located below the core catcher 200 and has the coolant channel 310 filled with a coolant.

Out of the channel structure 300, the coolant tank 400 for supplying a coolant to the coolant channel 310 through the first pipe 500 is formed.

The coolant tank 400 is located above the channel structure 300. The tank has a first space 410 filled with a coolant and a second space 420 through which the steam generated by the coolant circulation inside the coolant channel 310 is discharged.

The first pipe 500 for supplying a coolant to the coolant channel 310 is provided below the channel structure 300. A second pipe 600 for discharging steam generated through the coolant circulation in the coolant channel 310 to the atmosphere is provided above the channel structure.

One end of the first pipe 500 is connected to the coolant tank 400, and the other end of the first pipe 500 is connected to the channel structure 300. The first pipe receives the coolant from the coolant tank 400 and supplies coolant to a start portion A of an upward path located below the coolant channel 310.

Although not shown, additional valves may be installed in the first pipe 500 to regulate the amount of coolant flowing into the channel structure 300 through the first pipe 500.

One end of the second pipe 600 is connected to the channel structure 300 and the other end thereof is connected to the coolant tank 400. The second pipe discharges the vapor generated in the coolant channel 310 to the second space 420 inside the coolant tank 400.

The second pipe 600 was filled with a coolant before the severe accident. When the severe accident occurs in which the core is melted, a coolant in a liquid state and a vapor state are mixed therein. The liquid vapor in the vapor state is discharged to the second space 420 inside the coolant tank 400 through the second pipe 600.

Although not shown, a moisture separator and additional cooling equipment for increasing the collected number of droplets of the vapor discharged to the outside from the second space 420 may be additionally provided.

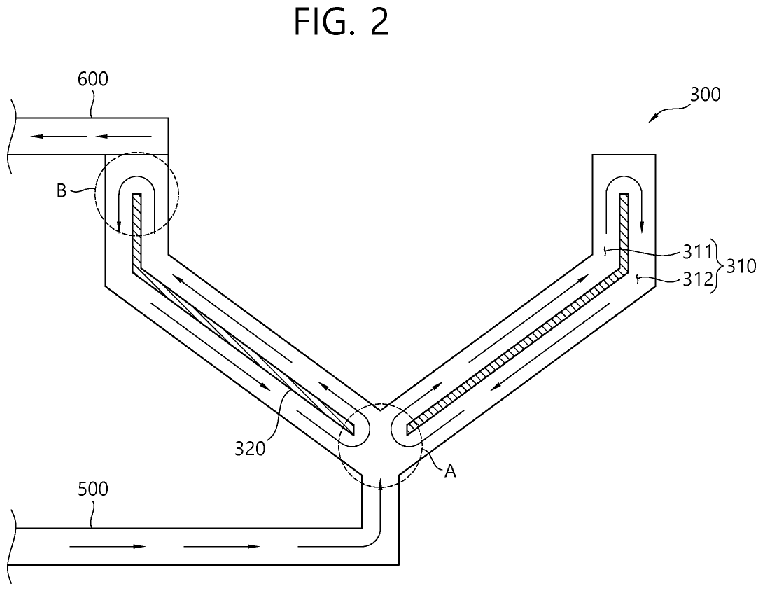

Referring to FIG. 2, the channel structure of the present invention is described.

FIG. 2 is an enlarged cross-sectional view of the channel structure of FIG. 1.

The channel structure 300 is located below the core catcher 200 and has the coolant channel 310 filled with a coolant.

The coolant channel 310 is divided into a first channel 311 adjacent to the core catcher 200 and a second channel 312 separated from the core catcher 200.

The channel structure 300 according to one embodiment of the present invention includes a partition member 320 for partitioning the first channel 311 and the second channel 312.

It is needless to say that the partition member 320 may be formed in a plate shape, but the present invention is not limited thereto, and the shape may be variously changed or may be modified as long as the shape is capable of generating coolant circulation in the coolant channel 310. Although not shown, a spacing maintaining portion for maintaining the spacing between the channels may be located in the form of scattering points or the like. In this case, the partition member 320 may be appropriately modified according to the shape and arrangement of the spacing maintaining portion.

The coolant channel 310 includes a start portion A of the upwards path along which the coolant begins to rise upward along the first channel 311, and a start portion B of the downwards path along which the coolant begins to descend downward along the second channel 312.

The first channel 311 and the second channel 312 are in communication with each other in the start portion A of the upwards path and the start portion B of the downwards path.

In a severe accident that the core is melted, the coolant rises along the first channel 311 and the coolant descends along the second channel 312. Thus, the coolant spontaneously cycle along and in the coolant channel 310.

The natural or spontaneous circulation may be described in detail as follows. In the case of the severe accident, the coolant supplied to the channel structure 300 through the first pipe 500 is heated due to the heat generated by the high-temperature molten core.

Thereafter, the coolant rising up along the first channel 311 is circulated from the start portion B of the downwards path, and descends along the second channel 312, and is recirculated again from the start portion A of the upwards path. In this connection, a portion of the coolant is vented to the atmosphere through the second pipe 600 in the vapor form.

By the discharged coolant, new coolant is replenished passively from the coolant tank 400 so that the channel structure 300 is filled with the coolant. This improves the cooling efficiency due to the addition of the coolant and smooths the natural circulation flow.

Accordingly, according to the present invention, the natural circulation of the coolant through the upwards flow and the downwards flow in the coolant channel 310 is performed. Thus, the molten core cooling using the coolant is efficiently performed.

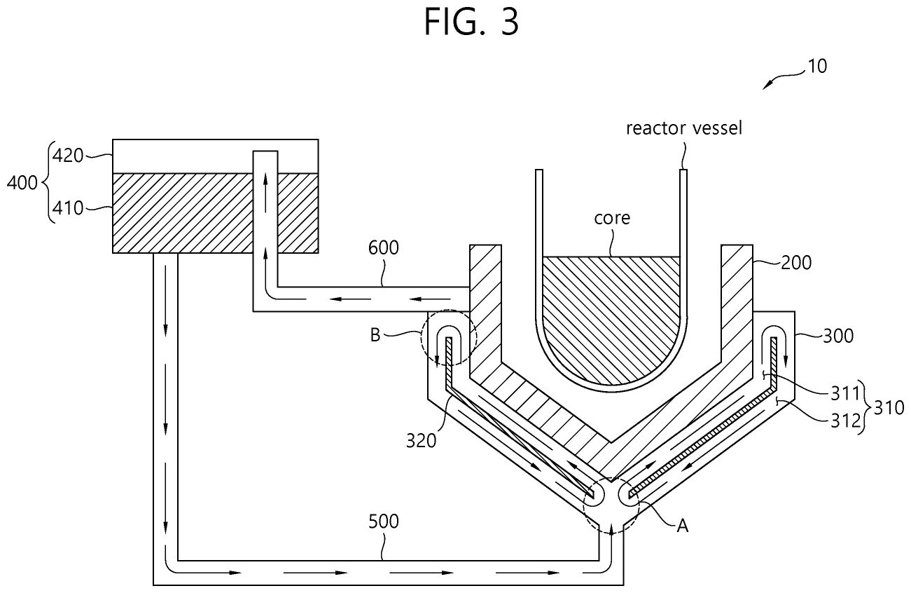

The coolant circulation in a passive molten core cooling apparatus according to the present invention is described with reference to FIG. 3.

FIG. 3 is a cross-sectional view of a passive molten core cooling apparatus showing the circulation of the coolant according to the present invention.

In accordance with the present invention, prior to the severe accident, the coolant tank 400, the first pipe 500 and the channel structure 300 were all filled with coolant. The coolant is maintained at a constant temperature due to the core catcher 200 spaced apart from the nuclear reactor vessel by a predetermined spacing and the sacrificial material layer formed between the core reactor 200 and the nuclear reactor vessel.

When the core melting occurs, the molten core penetrates the reactor vessel and melts the sacrificial material layer, the leaked molten core is collected by the core catcher 200 that collects the molten core that flows down or falls freely from the nuclear reactor vessel. In this connection, the coolant inside the channel structure 300 having the coolant channel 310 located below the core catcher 200 and filled with the coolant is heated. The coolant raised along the first channel 311 descends along the second channel 312 such that the natural circulation of the coolant through the coolant channel 310 is performed.

Specifically, as shown in FIG. 3, in a severe accident where the core is melted, the coolant heated by the heat generated by the high temperature molten core rises along the first channel 311 from the start portion A of the upwards path of the channel structure 300 and reaches and turns around and descends downwards along the start portion B of the downward path. The coolant descends along the second channel 312 and is recirculated again from the start portion A of the upwards path.

In this connection, a portion of the coolant that spontaneously circulates in and along the coolant channel 310 may be vented to the atmosphere through the second pipe 600 in vapor form. Only some droplets are collected through the second space 420 of the coolant tank 400 as a liquid coolant.

Although not shown, a moisture separator and a separate cooling facility may be additionally provided to increase the collection of the liquid droplets discharged to the outside from the second space 420.

Thereafter, the coolant as much as the amount of the vapor discharged to the atmosphere through the second pipe 600 is supplied to the first pipe 500 from the coolant tank 400 arranged at a higher level than the channel structure 300 due to the gravity. The coolant supplied through the first pipe 500 flows into the start portion A of the upwards path at the bottom of the channel structure 300.

In this process, the complete filling of the coolant in the coolant channel 310 in the channel structure 300 is performed passively such that a certain amount of cooling water is maintained therein.

According to the present invention, the passive molten core cooling apparatus is provided that maintains a constant coolant amount due to hot molten core and coolant heating, natural circulation by boiling in the coolant channel 310, and passive replenishment of coolant from the coolant tank. In this connection, any mechanical parts that need to be operated for the operation of the equipment are not required. This can prevent the effects from the equipment failure or operator's mistake.

In addition, the molten core and coolant cannot come into direct contact with each other, so that the molten core-coolant interaction leading to the steam explosion can be prevented.

The embodiments as described above are illustrative of the present invention, and the present invention is not limited thereto. It will be understood by those skilled in the art that various changes in form and details may be made therein without departing from the spirit and scope of the present invention as defined by the appended claims.

1. A passive molten core cooling apparatus comprising:
a reactor vessel;
a core catcher located below the reactor vessel;
a channel structure having a coolant channel located below the core catcher and filled with a coolant; and
a coolant tank communicating with the channel structure through a first pipe and supplying a coolant to the coolant channel through the first pipe,
wherein the coolant channel is divided into a first channel adjacent to the core catcher and a second channel spaced away from the core catcher, wherein the first channel and the second channel are communicated to each other.

2. The passive molten core cooling apparatus of claim 1, wherein when a severe accident occurs, the coolant rises up along the first channel, and the coolant descends along the second channel, such that the coolant is spontaneously circulated through the coolant channel.

3. The passive molten core cooling apparatus of claim 2, wherein the coolant channel includes:
a start portion of an upwards path along which the coolant begins to rise up along the first channel; and
a start portion of a downwards path along which the coolant begins to descend along the second channel.

4. The passive molten core cooling apparatus of claim 3, wherein the coolant channel is constructed such that the first channel and the second channel are in communication with each other at the start portion of the upwards path and the start portion of the downwards path.

5. The passive molten core cooling apparatus of claim 1, wherein the channel structure includes a partition member for partitioning the coolant channel into the first channel and the second channel.

6. The passive molten core cooling apparatus of claim 5, wherein the partition member has a plate shape

7. The passive molten core cooling apparatus of claim 1, wherein the apparatus further includes a second pipe,
wherein one end of the second pipe is in communication with the channel structure, and the other end thereof is exposed to an atmosphere,
wherein the second pipe discharges vapor generated via the coolant circulation in the coolant channel to the atmosphere.

8. The passive molten core cooling apparatus of claim 1, wherein the coolant tank is disposed above the channel structure.

9. The passive molten core cooling apparatus of claim 7, wherein the coolant tank has:
a first space filled with the coolant; and
a second space, wherein steam discharged through the second pipe is discharged into the atmosphere through the second space.

10. A passive molten core cooling apparatus comprising:
a reactor vessel;
a core catcher located below the reactor vessel;
a channel structure having a coolant channel located below the core catcher and filled with a coolant, wherein the channel structure includes a partition member for partitioning the coolant channel into a first channel and a second channel;
a coolant tank for supplying a coolant to the coolant channel;
a first pipe communicating with the coolant tank; and
a second pipe for discharging vapor generated in the channel structure to atmosphere,
wherein the coolant in the coolant channel upwardly and downwardly flows and thus spontaneously circulates in the coolant channel,
wherein coolant is replenished passively from the coolant tank by an amount of coolant as discharged through the second pipe in a vapor state.

11. The passive molten core cooling apparatus of claim 10, wherein the coolant channel is divided by the partition member into a first channel adjacent to the core catcher and a second channel spaced away from the core catcher, wherein the first channel and the second channel are communicated to each other.
